(19) United States
(12) Patent Application Publication
(10) Pub. No.: US 2019/0236627 A1
(43) Pub. Date: Aug. 1, 2019

(54) METHOD FOR PRICING DATA IN A SHARING ECONOMY

(71) Applicant: BMLL Technologies, Ltd., London (GB)

(72) Inventor: Hugh L. Christensen, London (GB)

(21) Appl. No.: 15/880,874

(22) Filed: Jan. 26, 2018

(51) Int. Cl. G06Q 30/02; G06Q 10/06; G06N 99/00; G06N 7/00

(52) U.S. Cl. CPC G06Q 30/0206; G06N 7/005; G06N 99/005; G06Q 10/067

(57) ABSTRACT

Disclosed herein is a method for determining the fair price of data for distribution in a collaborative consumption setting via an electronic network, wherein the price of the data is determined using a quantitative statistical model, wherein one input to the statistical model is pricing data from any complementary sales channels, a second input to the statistical model is the age of the data, and a third input into the statistical model is the information content of the data.

### FIELD OF THE INVENTION

This invention generally relates to a mechanism to price data for on-line distribution on a rental basis. More particularly, the present invention is directed to a method to price data on a web-based platform in a sharing economy marketplace, allowing both supplier and consumer to benefit from efficient pricing of the underlying.

### BACKGROUND OF THE INVENTION

In this section we introduce the background of the invention and place it in the context of existing patents and academic literature. We begin by considering three interrelated topics, namely economic matching events, telemetry and on-line marketplaces. We then place these concepts into the framework against which the presented method is applied. Subsequently we give background on mathematical concepts relevant to the invention such as statistical entropy and mutual information.

### Data and the Sharing Economy

The invention has been driven by a combination of factors: cloud computing as a utility, significant increases in the number of sensors recording data, significant increases in the volume of data recorded, an increased requirement to extract value from data, and a growing acceptance of out-sourced and shared solutions to this task. These factors are applicable across a wide range of datasets, which can be broadly divided into the three categories discussed below.

### Economic Matching Data

The first category is data generated by economic matching events. These datasets take the form of a Limit Order Book. A limit order book is a store of traders intentions in a marketplace [1]. From this data alpha generators can construct trading strategies and regulators can police those strategies. So it is assumed the data is valuable and owners of this data typically seek to monetize it. Primary producers of this data are the financial markets but analogous data is also created in other settings such as on-line retail markets, peer-to-peer sharing economy markets, exchange-based sports betting and luxury auction markets. A selection of different limit order books are further illustrated in FIG. 1, and we consider a range of limit order books in more detail here.

Financial market data is generated as the result of the workings of the financial system. The bulk of this data relates to activities that take place on exchanges or platforms. An exchange is a venue where multiple parties connect electronically to buy or sell securities. In finance the process which generates the limit order book is the continuous double-sided auction. The study of the financial limit order book dataset is a key area of activity for traders [2, 3], regulators and compliance [4] and academics [5, 6, 7]. The financial limit order book has been the subject of extensive patents, for example [8], which describes a specialized method for displaying and analysing limit order books. In addition to exchange generated data, data is generated by the underlying assets such as companies or commodities—this data is often used in conjunction with the limit order book data. Financial market data is the second biggest expenditure in financial services after payroll and headcount and as such is a well established commercial field [9]. Examples of companies involved in the field of financial data are Bloomberg and Reuters.

Closely related to the finance dataset is the bitcoin dataset. Bitcoin is a digital asset that trades on platforms in a similar way to traditional financial assets [10]. Analogous to financial market data, bitcoin data exists in the format of a limit order book and sees a range of analysis activities applied to it, for example [11, 12]. Bitcoin has also been the subject of a wide range of patents, such as [13] which describes a novel method for constructing, securing and utilizing a physical cryptocurrency wallet. Examples of companies in the bitcoin field include Kraken, BitStamp and Coinbase.

Betting on sporting events such as football, horse racing and tennis generates data, and there are often multiple markets on any one event (win/loss markets, who scored which goal and when, which horse won which race, each way betting etc.) [14]. Traditionally this has been through bookmakers who broadcast a price feed [15], though now betting can also take place through betting exchanges such as Betfair and Matchbook [16]. These exchanges generate limit order book information in the same way as financial exchanges and sporting market participants use this data for analysis prior in the same way as their financial counterparts. A prior patent in this field is [17], which describes novel technologies underlying the operation of an electronic sports betting exchange system.

Another type of auction mechanism commonly used is the English Auction, as typically used by auction houses such a Christies or Bonhams [18]. This data generating mechanism is a one-sided limit order book representing the good to be sold [19].

Prior patents relating to English auctions include [20], which details a technology for carrying out on-line combinatorial auctions with bid restrictions, as well as [21], which describes a method for trial on-line English auctions for the pricing of items to be sold at a later data, and also [22], which describes an asset-class specific system for the advertising and auctioning of real estate.

E-commerce is the trading or the facilitation of trading in products or services using the internet. At the heart of e-commerce platforms such as Amazon or Ebay are inventories of stock which suppliers sell and consumers buy. This queue of orders can be again represented as a limit order book. Participants in these platforms exhibit differing behaviours to those in the finance or sports markets, but still use data to inform behaviour on the platform [23, 24]. Previous work relating to pricing in e-commerce has been patented, for example [25], which specifies a method for the dynamic pricing of items sold through an electronic marketplace.

### Telemetry Data

The second category of data is telemetry data. The volume of telemetry data recorded has significantly increases due to the proliferation of sensors. Examples from this category include healthcare data generated by personal fitness devices and smartphones, domestic energy and utilities consumption data produced by smart home technology, and physical telemetry data from a range of industries including petrochemical exploration, aerospace and meteorology.

The Internet of Things (IoT) refers to the increasing amount of sensor technology being embedded in everyday objects. This technology generates vast amounts of data that can be aggregated and monetized. Many different entities are interested in accessing and mining data that IoT telemetry technology collects [26]. Utility companies want to collect as much data as possible about household consumption in order to optimize their operating processes, hence saving money [27]. Another application of IoT data for use in the profiling of individuals for better targeting of marketing campaigns [28]. Relevant patents in the IoT space include [29], submitted by Quallcomm Inc, which patents an automated method for processing IoT data analytics, as well as [30], submitted by Tata Consultancy Services Ltd, which describes a method for the aggregation and analysis of IoT data using social networks.

Meteorology and weather data companies generate data through various sensors belonging to different commercial or governmental bodies, examples include the Met Office, AccuWeather, and MeteoGroup [31]. Analysis of this data is the purpose of meteorology, for example to study climate change [32]. Patents in this field include [33], which specifies a method for real-time tracking of weather movements through the aggregation of of data collected from multiple distributed remote sensors, in particular for use in storm prediction and meteorological nowcasting.

Whereas meteorology sensors record data primarily from the atmosphere, another set of industrial telemetry sensors record data from below the ground. These sensors are used for oil, gas and seismic surveys [34, 35, 36]. Telemetry is used to transmit drilling mechanics and formation evaluation information, in real time, as a well is drilled. When drilling, pressure waves are translated into useful information after DSP and noise filters. This information is used for Formation Evaluation, Drilling Optimization, and Geosteering. Examples of companies involved in this field are Shell, BP and Schlumberger. An example of a patent in this field is [37], submitted by Amaco Corp., which details a method for stratigraphic analysis of geophysical data, using features identified in seismic signals for the identification of different rock strata.

A further example of patents relevant to geophysical telemetry is [38], which describes a method for transmitting data describing drilling conditions upwell from the base of an active drill site using acoustic signalling.

Healthcare generates data from a range of sensors including medical imaging and biometric testing [39, 40] This data may be recorded at a range of hospitals and may be highly confidential due to being patient-sourced. Nonetheless, the data has value to both clinicians and pharmaceutical companies for applications such as diagnosis and drug-design [41]. Patents in this field include [42], which details a method for the aggregation and normalization of clinical and data from multiple sources with varied reporting standards, and also the distribution thereof for the purposes of data mining.

A closely related field to healthcare is genomics [43, 44]. Genomics is the field of generating genome data from biological tissue, allowing subsequent analysis using techniques in bioinformatics [45]. An example of a patent in the field of genomic data analysis is [46], submitted by Portable Genomics Inc., which describes a method for organizing and visualizing human genome data on a portable electronic device. Examples of companies in this field include GSK, Pfizer and Bayer. As with other datasets here, there is non-linear and cumulative value in analysing different datasets against each other.

### On-Line Marketplace Data

The third category of data consists of datasets which are generated as a result of online marketplaces which sell services or goods. The online marketplace is an instance of the sharing economy (also known as collaborative consumption) which refers to peer-to-peer based sharing of access to goods and services, coordinated through community-based markets and platforms [47, 48]. Examples include food delivery (eg Deliveroo), peer-to-peer lending (eg Zopa), transportation (eg Uber), accommodation (eg Airbnb), auctions (eg ebay), review aggregation (eg Rotten Tomatoes, Tripadvisor) audio (eg Spotify) and visual (eg Netflix). These platforms all generate data on their user behaviour—often this data will be valuable for analytical purposes either to the platform owner or to platform participants.

From these examples it can be see that on-line marketplaces can provision a wide range of goods or services. Some of the underlyings that are best suited for on-line marketplaces are data products (of which Spotify and Netflix are examples). Reasons for this include the fact that data is easily shared over electronic networks (such as the internet) in a global fashion in a way that physical underlyings can not be and that disparate datasets also disproportionately benefit from centralized curation.

### SUMMARY OF INVENTION

In the above three sections we have considered data generation from three different but sometimes overlapping sources. Independent of where the data comes from or what the data generating process is, if the data is valuable then the data owner may wish to monetize that data. We have seen that in the sharing economy the on-line marketplace is a good setting to do this. Key to providing data in a collaborative consumption environment is the requirement to price the data. As the effective costs of ownership are shared between users, the total cost of the data consumption is less than outright ownership. At the same time, the cost levied is no longer for outright ownership but for rental, generally for unit time or unit consumption. By enabling users to use data in a more efficient fashion, the cost-per-user will decrease. Whilst this may initially appear to reduce revenues for data owners, such on-line marketplaces have the potential to reach a much larger number of consumers than traditional distribution channels.

As sharing economy platforms are a relatively new phenomenon, the literature on pricing in these platforms is limited, however some literature does exist. In one paper Le Chen et al. consider the pricing algorithm of Uber and find that in contrast to the Airbnb Aerosolve algorithm [49], Uber's algorithm is not disclosed but is estimated to be dynamically set based on surge pricing [50].

Once the data has been priced and consumers are able to access it, the consumer value extraction process can occur. This process is varied and depends upon the nature of the dataset. For financial data, the process is software based analysis leading to better trading decisions and/or policing those involved in trading decisions. For audio-visual data, the process is visual or aural for entertainment. For goods the value comes from receiving access to the goods in a timely and efficient fashion. For healthcare data, the value is in better and more accurate diagnosis and treatment.

### Entropy and Mutual Information

Entropy is a measure of a random variable's uncertainty [51, 52, 53]. Mutual information is a measure of association between two random variables—it measures how much knowing one random variable reduces uncertainty about the other.

Given two discrete random variables X and Y with a joint probability distribution p(x, y) and marginal distributions p(x) and p(y), the Entropy H(X), Joint Entropy H(X, Y), Conditional Entropy H(X|Y) and Mutual Information I(X;Y) are defined respectively as

$$H ( X ) = - {\sum }_{x} p ( x ) log p ( x ) , \\ H ( X , Y ) = - {\sum }_{x , y} p ( x , y ) log p ( x , y ) , \\ H ( X \vert Y ) = - {\sum }_{x , y} p ( x , y ) log p ( x \vert y ) , \\ \begin{matrix}I ( X ; Y ) = {\sum }_{x , y} p ( x , y ) log ( \frac{p ( x , y )}{p ( x ) p ( y )} ) \\ = H ( Y ) - H ( Y \vert X ) = H ( X ) - H ( X \vert Y ) .\end{matrix} \qquad ( 1 )$$

If X and Y are dependent, then the value of one variable completely determines that of the other. The mutual information reflects this—we have p(x, y)=p(x)=p(y), H(X)=H(Y), and so the mutual information is equal to the entropy of X or Y.

Conversely, X and Y are independent (meaning p(x, y)=p(x)p(y)) if and only if and the mutual information is zero—knowledge of one variable carries no information about the value of the other. Hence, I(X; Y) can serve as a measure of the information contained in a dataset's features. Given two feature F₁ and F₂, I(F₁; F₂) will be relatively large when F₁ and F₂ are highly associated (i.e exactly when knowing one feature reduces uncertainty about the other), and small when either feature is a poor indicator of the other.

We estimate I(X; Y) given a set of T observations {xₜ, yₜ}ₜ₌₁^{T} of two features, x and y, as follows, defining C(x)=Σₜ₌₁^{T} [symbol] {xₜ=x} and C(x, y)=Σₜ₌₁^{T} [symbol] {xₜ=x, yₜ=y} to be the marginal and joint frequencies of each unique observed feature value:

$$I ( X ; Y ) = \frac{1}{T} {\sum }_{x , y} C ( x , y ) log \frac{T \times C ( x , y )}{C ( x ) C ( y )} .$$

Previous patents concerning entropy-based algorithms include [54], submitted by Google Inc, which details a method for feature selection using mutual information statistics, as well as [55] submitted by Robert Bosch GmbH, which describes a method for efficient feature selection and ranking using maximum entropy modelling.

Further relevant patents are [56], submitted by the US Navy, which describes a signal processing method using mutual information statistics, and also [57], submitted by IBM Corp., which describes an adaptive pattern recognition system based on mutual informationderived tree structures.

### Features and Feature Selection

Machine Learning is the field concerned with the study of pattern recognition and automated data analysis [58]. Within machine learning, feature selection is an important sub-field relating to techniques and methods for designing and extracting relevant representations of data [59].

Each data point in an unprocessed dataset consists of a vector of real measurements or observations (e.g for a dataset of images, each data point is a single image defined by a vector of pixel values). This is called the Input-Space. Feature extraction algorithms find values derived from the input space that are informative about the data or have desirable statistical properties. These derived values are the features, and usually take the form of feature vectors, with their span being described as the Feature-Space. Further data analysis can then take place in the feature space, in which data points are considered in terms of their associated feature vectors rather than the raw observations.

Examples of common feature selection algorithms are:

### Linear Regression

Linear regression method finds a linear mapping f(X)=Xβ+ϵ that best fits a set of labelled data {(xᵢ, yᵢ)}ᵢ₌₁ⁿ in the input space, with respect to minimizing some error function E(y, f(X)). This linear mapping defines an affine transformation from the input space into a feature space in which future observed data is analysed. For the common ordinary least-squares error function, the following closed form solution for the optimal value of \hat{β} exists:

\hat{β}=(X^{T}X)⁻¹X^{T}y

### Principal Component Analysis (PCA)

The PCA algorithm identifies features in a dataset that have maximal sample variance across all the data points. Equivalently, the features extracted by PCA are the eigenvectors {q₁, . . . , qₙ} of the input-space covariance matrix Σ, so that for Q=[q₁| . . . |qₙ] and diagonal matrix of eigenvalues A, we have

Σ=Q^{T}ΛQ

PCA projects each data point x onto Q^{T}x in the feature space defined by the span of these eigenvectors[60].

### Kernel Methods

Kernel methods make it possible to consider data in a latent feature space by using a Kernel function K(x, x′). The kernel defines an inner product between feature vectors in the feature space in terms of the corresponding vectors in the input space. One popular type kernel function is the Gaussian Kernel, often called a Radial Basis Function, defined as

$$K ( x , {x}^{′} ) = exp ( - \frac{{\vert \vert x - {x}^{′} \vert \vert}^{2}}{2 {σ}^{2}} )$$

for some constant σ [58].

Much work has been done previously applying concepts from information theory and statistical entropy to problems in feature selection [61, 62, 63].

An example of a patent concerning methods for feature selection is [64], which details a general method for identifying features in spatially or temporally indexed data.

Further relevant patents include [65], submitted by the Microsoft Corporation, which describes a method for feature extraction from search engine queries, for the purpose of web page ranking, and also [66], submitted by Google Inc., which describes a method for using a Bayesian likelihood model and feature selection to rank documents related to search queries.

### Bayesian Statistics

Bayesian inference uses Bayes' Rule, displayed in Equation 2, and conditional probability to build and reason with statistical models.

$$P ( X = x \vert Y = y ) = \frac{P ( Y = y \vert X = x ) P ( X = x )}{P ( Y = y )} \qquad ( 2 )$$

Suppose we have a random variable X, which we assume to have some parametric distribution p(X=x|θ) (this is called the Liklihood). We can combine observations of X with Bayes' rule to estimate a distribution for the parameter θ. Treating θ as a random variable, we assume a Prior distribution p(Θ=θ)=p(θ). Given a sample x from X, we use Bayes' rule to get the following expression for the Posterior distribution p(θ|x):

$$p ( θ \vert x ) = \frac{p ( x \vert θ ) p ( θ )}{p ( x )} ∝ p ( x \vert θ ) p ( θ )$$

$$Posterior ∝ Liklihood \times Prior$$

Given sample data x_{1:n} of n independent observations of X, we can repeatedly update the posterior distribution for θ as follows,

$$p ( θ \vert {x}_{1 : n} ) ∝ p ( {x}_{n} \vert θ ) p ( θ \vert {x}_{1 : n - 1} ) ∝ … ∝ p ( θ ) {\prod }_{k = 1}^{n} p ( {x}_{k} \vert θ )$$

In the limit, as n→∞, the mode of the posterior distribution will converge on θₘₐₚ, the value of θ which maximizes the likelihood of the observed data. An illustration of Bayesian updating is shown in FIG. 2. Further details on Bayesian statistics can be found in [58].

### OBJECTS AND SUMMARY OF THE PRESENT INVENTION

The invention provides a generalized method for pricing data for rental distribution in an sharing economy on-line marketplace. The invention allows data from many different sources to be priced consistently, and further provides a framework for direct value comparison of complex datasets of the same type. The invention addresses problems in the effective sharing and commercialisation of ‘big data’ both within and across a wide range of industries, including quantitative finance, digital marketing, e-commerce, biotechnology and academia.

### BRIEF DESCRIPTION OF THE FIGURES

The foregoing features of the present invention may be better understood by review of the following description of an illustrative example thereof, taken in conjunction with the drawings that follow.

FIGS. 1A-1D show embodiments of four examples of Limit Order Book data structures found in different settings.

FIG. 2 shows an Illustration of an embodiment of the process of Bayesian Updating of a prior distribution.

FIG. 3 shows an embodiment of the pricing method's price surface as a function of information and age, generated with sample limit order book data, and with parameters (w, λ, α)=(0.5,0.008,0.01). Superimposed are example snapshots using sample data displaying what the positions of different London Stock Exchange Cash Equity limit order books on the pricing function surface would have been on Feb. 1, 2015.

FIGS. 4A-4F show an embodiment of example data features. Each feature's time series is plotted with the feature's histogram superimposed.

FIGS. 5A-5F show an embodiment of example joint distributions of descriptive data features with lagged return. For visualisation purposes, those data points for which the lagged return is zero have been removed from these plots.

FIG. 6 shows an embodiment of exponential decay of the price age component, with example rate parameter λ=0.008.

FIG. 7 is a chart showing an embodiment of the effect of discounting on data prices.

FIG. 8 shows a schematic of the standard components of RESTful API design.

FIG. 9 shows a graph illustrating an embodiment of the structure of data flow through the platform from owner to customer.

### DETAILED DESCRIPTION OF THE INVENTION

### Overview

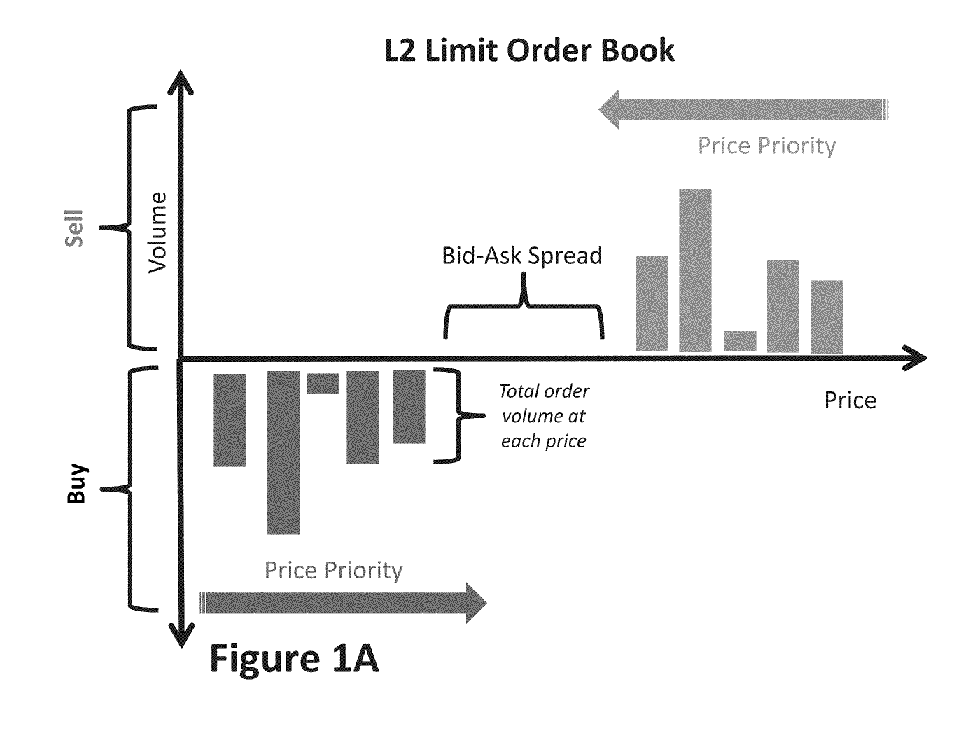

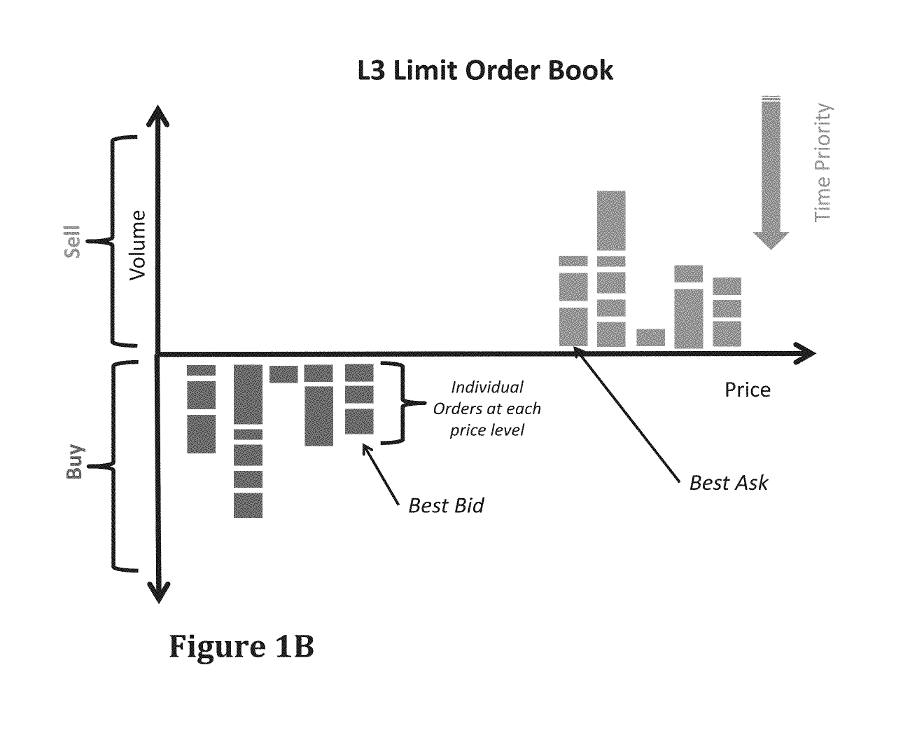

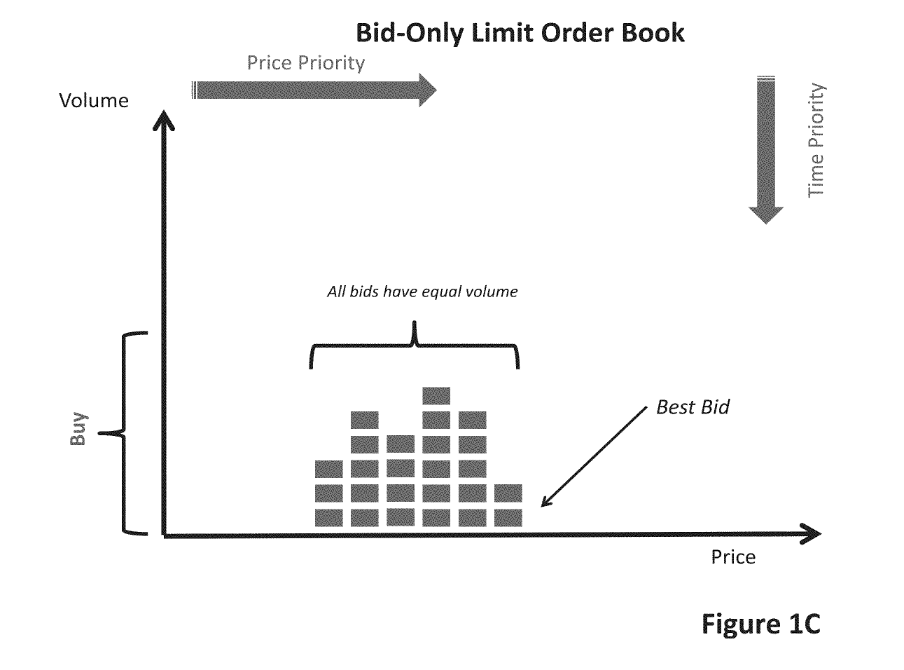

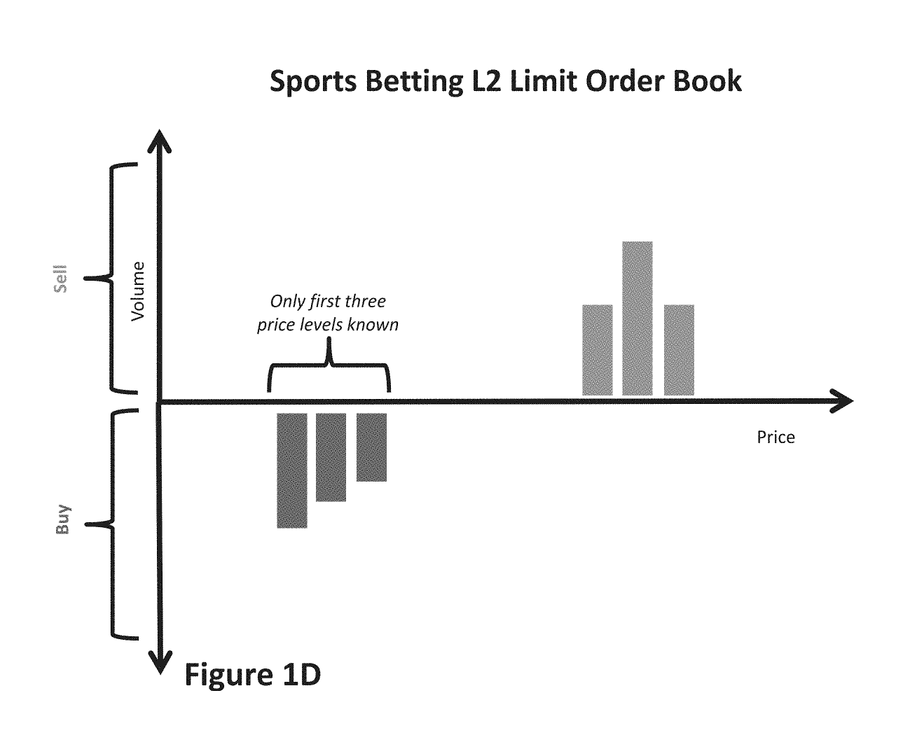

As mentioned, in part, above, FIGS. 1A-1D show examples of Limit Order Book data structures found in different settings. The L2 Limit Order Book datasets of FIG. 1A describe the total volume of orders at each price level for bid and ask (i.e buy and sell) orders. The bid-ask spread is the difference between the lowest ask and highest bid prices. An example of this dataset would be the CME e-mini S&P 500 contract. The L3 Limit Order Book of FIG. 1B is higher resolution than L2 data. The volumes at each price level are broken down into their constituent individual order volumes. The orders are arranged by time priority, such that incoming orders are added to the top of the columns, and executed orders are removed from the bottom. An example of this dataset would be the LSE rebuild order book dataset for Vodafone PLC cash equities. The bid-only order book of FIG. 1C, is such as would be seen in an English Auction, where many participants place competing bids for a single transaction, e.g., an auction of single fine art item at Sotheby's. The order book dataset of FIG. 1D is from a sports betting market, for example the win/loss match odds market on a English Premier League football game. Typically only the first three bid/ask price levels are broadcast at any one time.

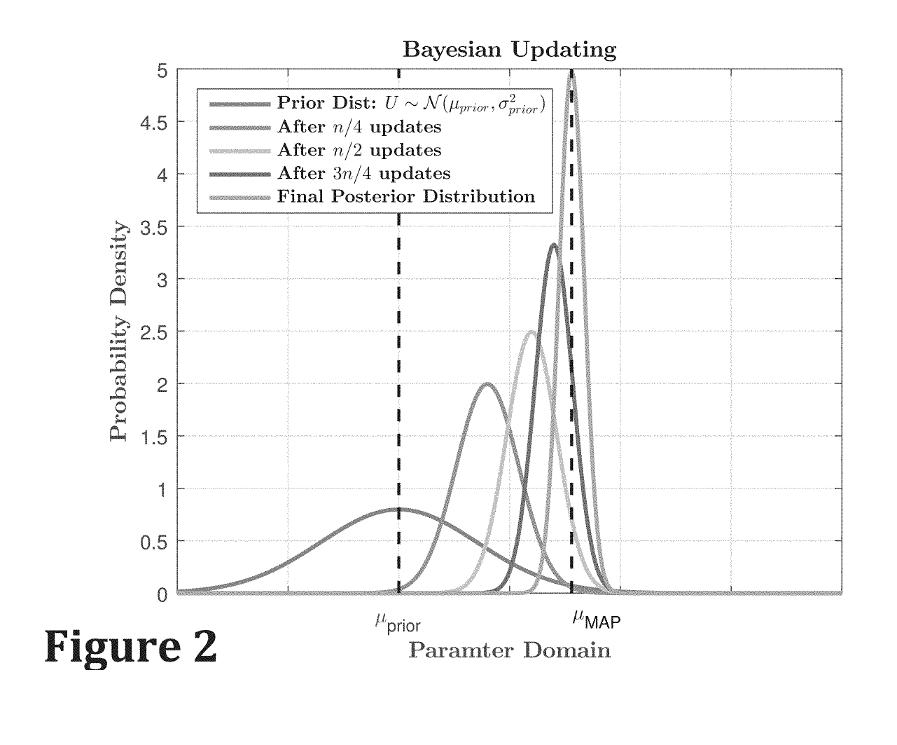

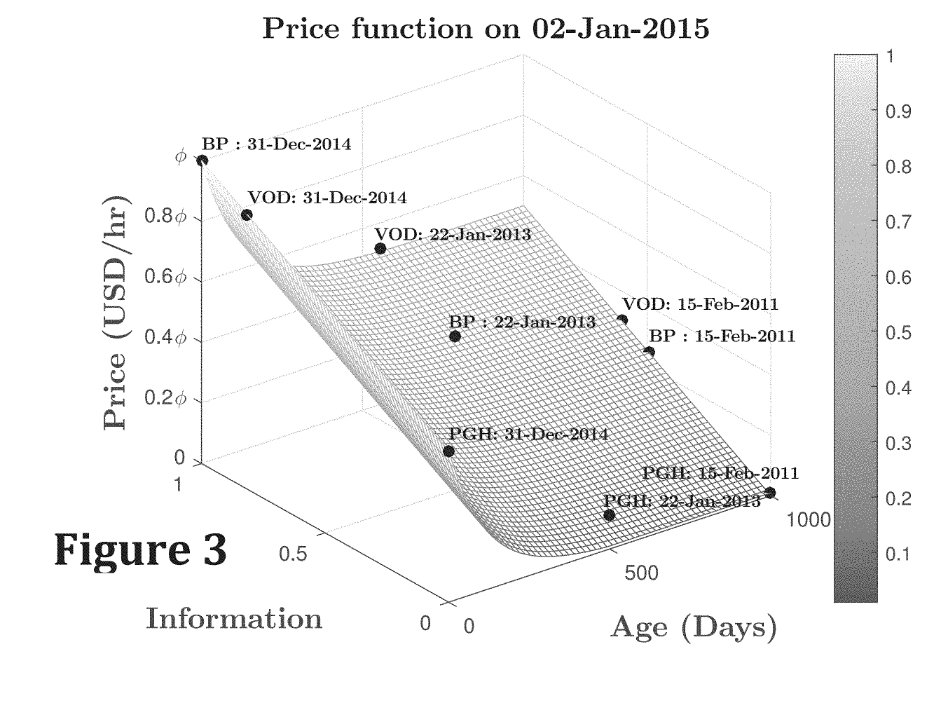

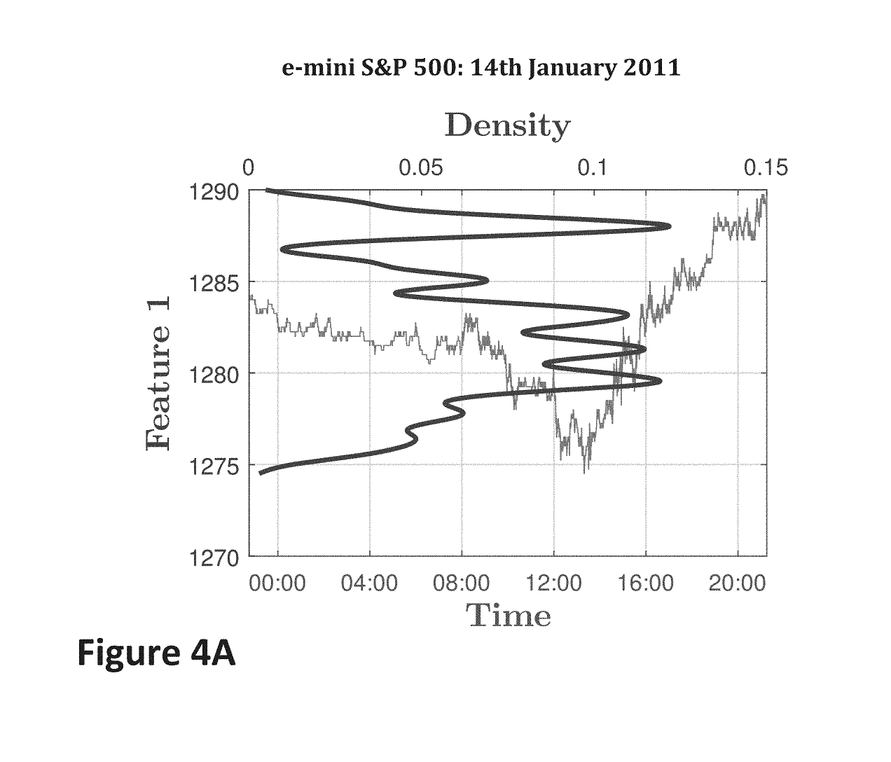

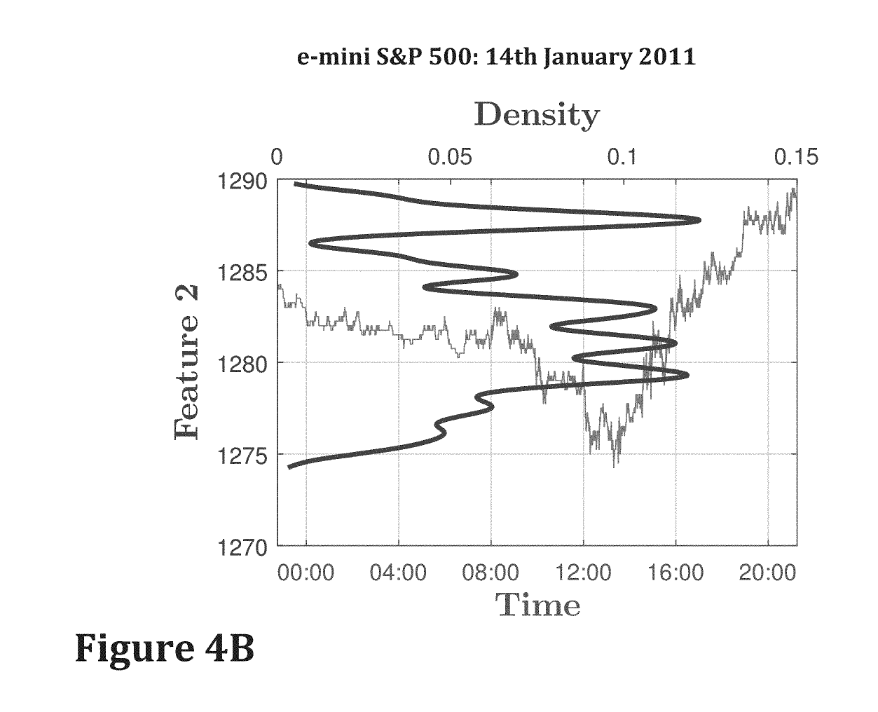

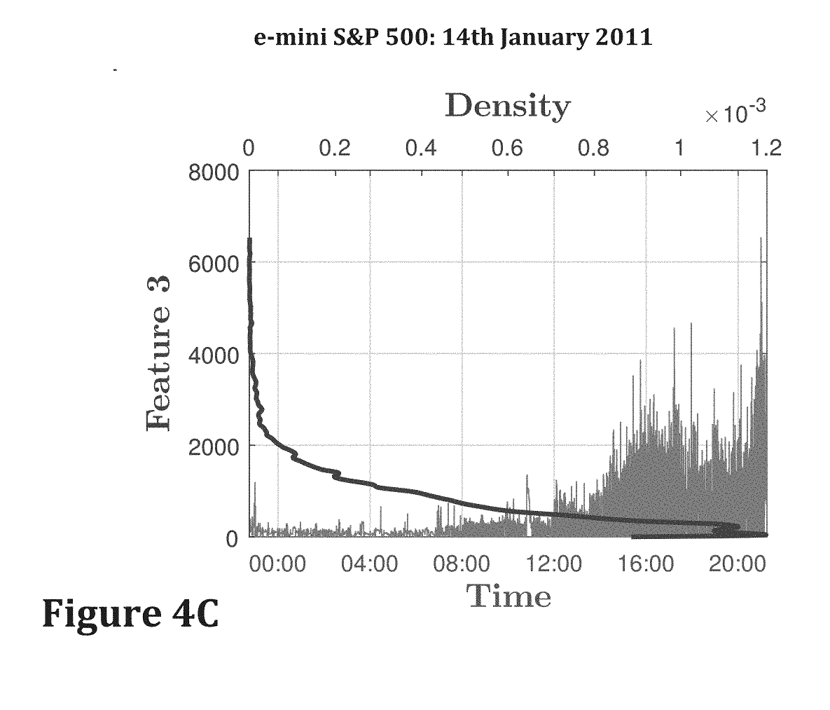

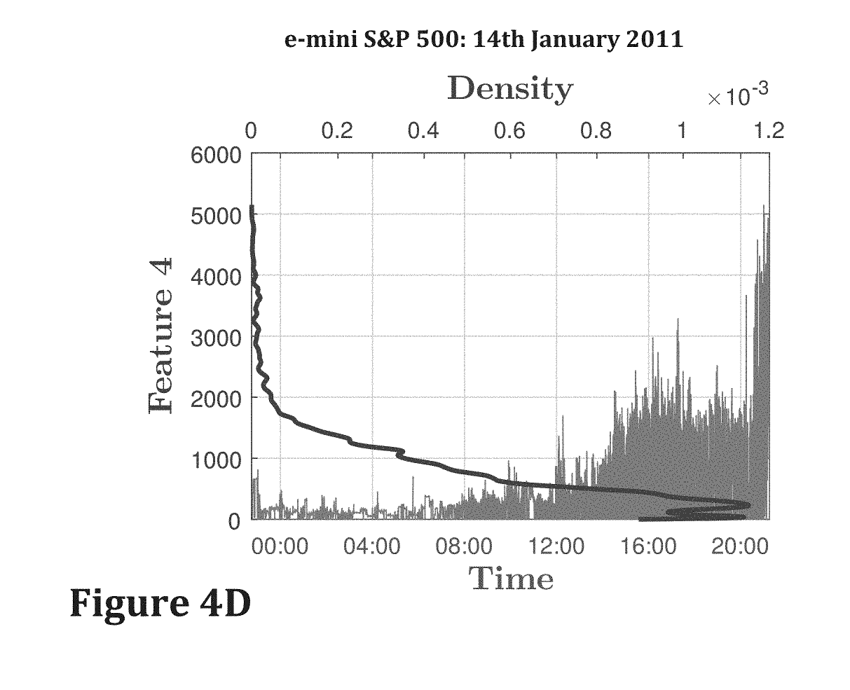

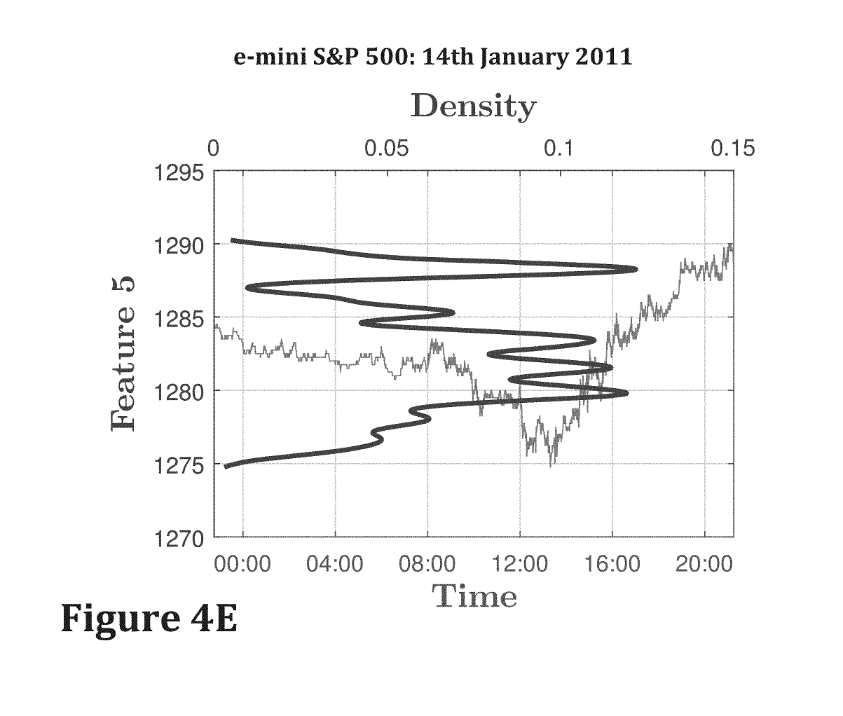

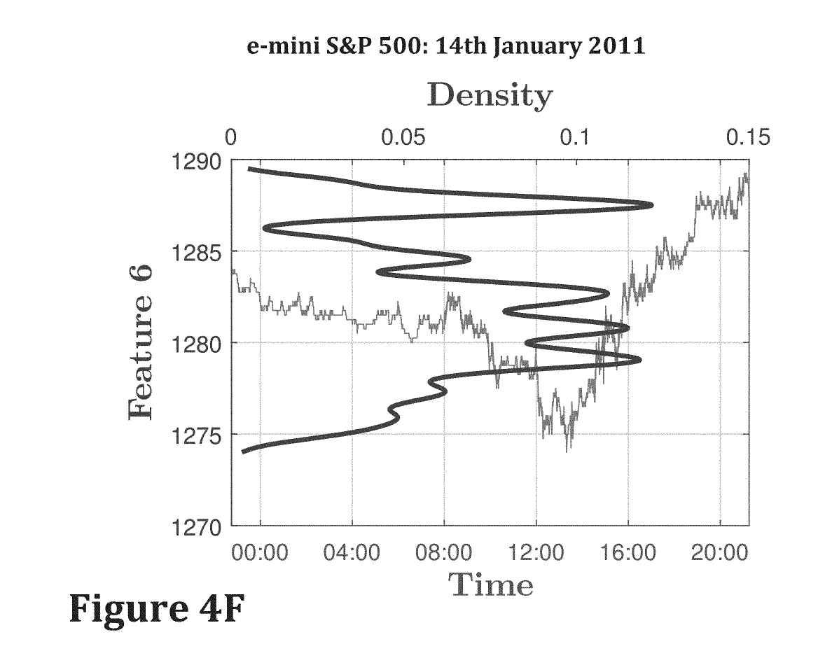

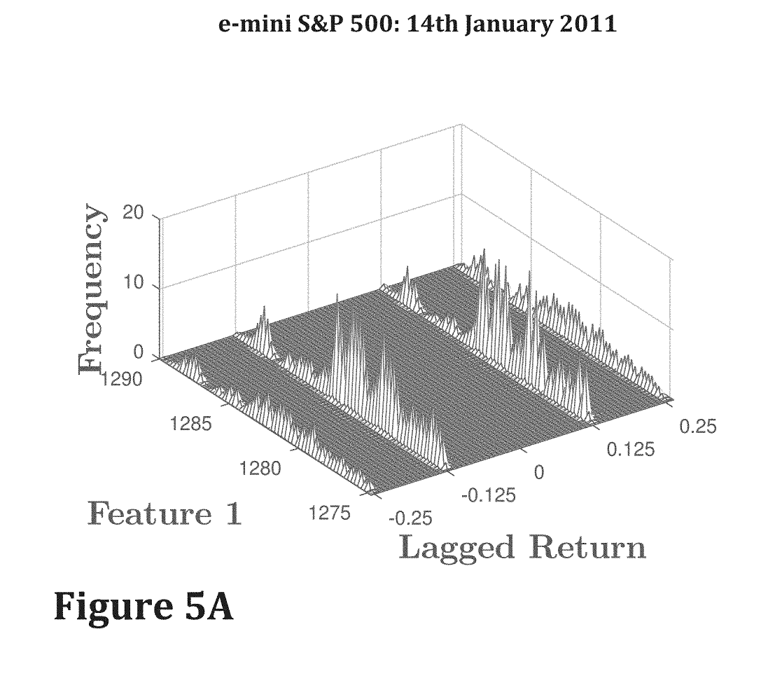

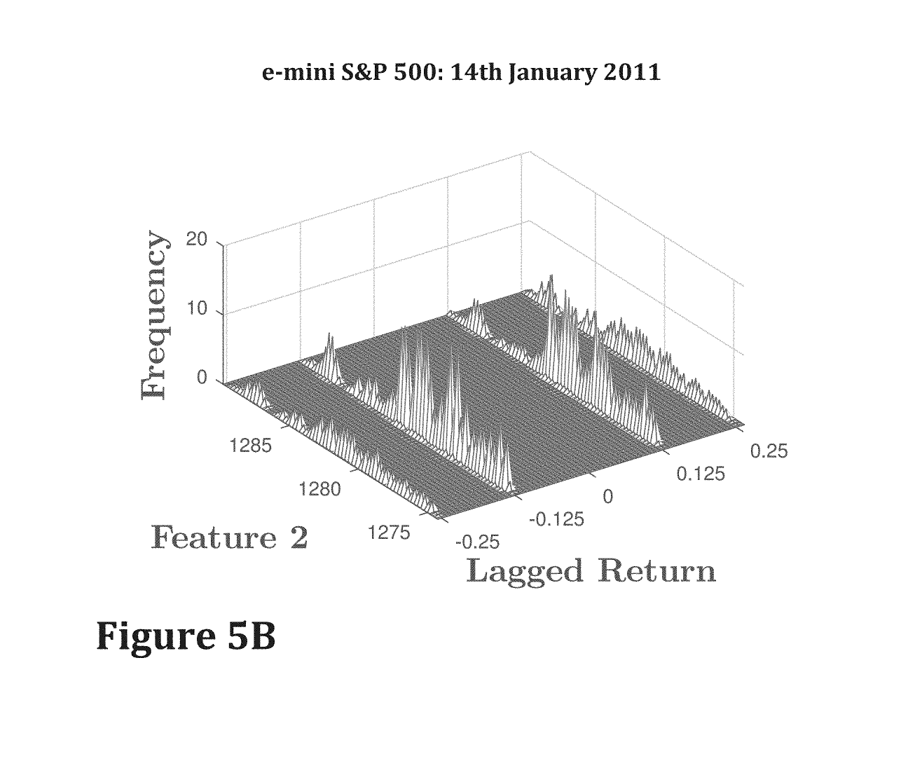

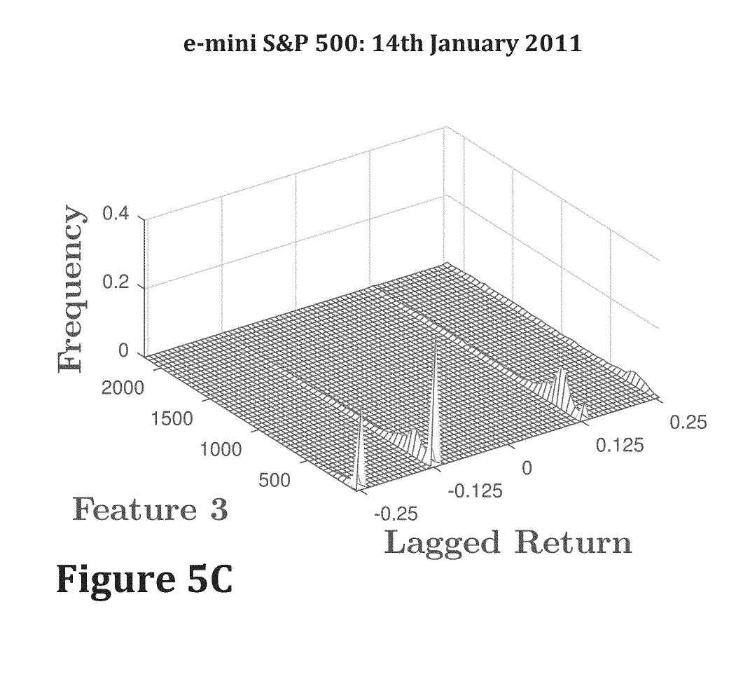

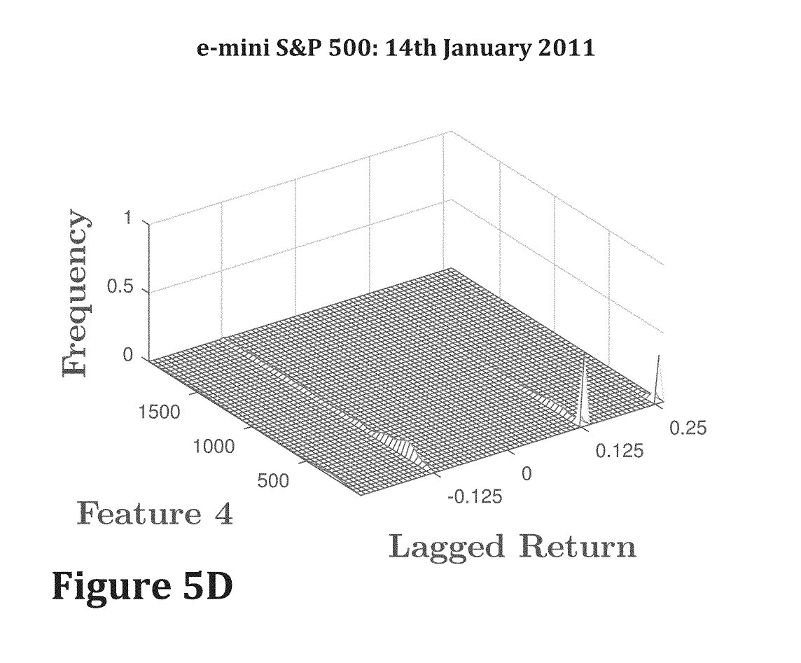

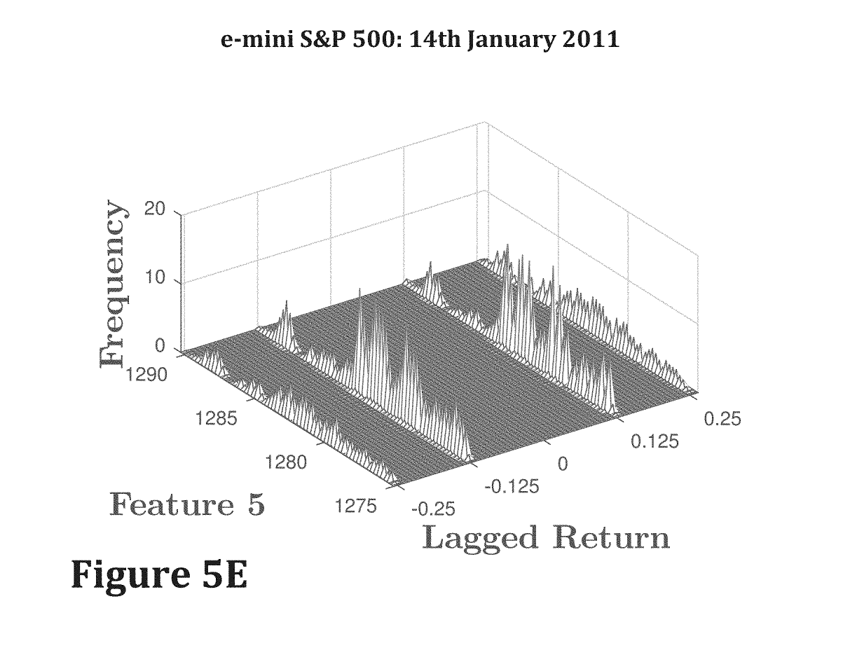

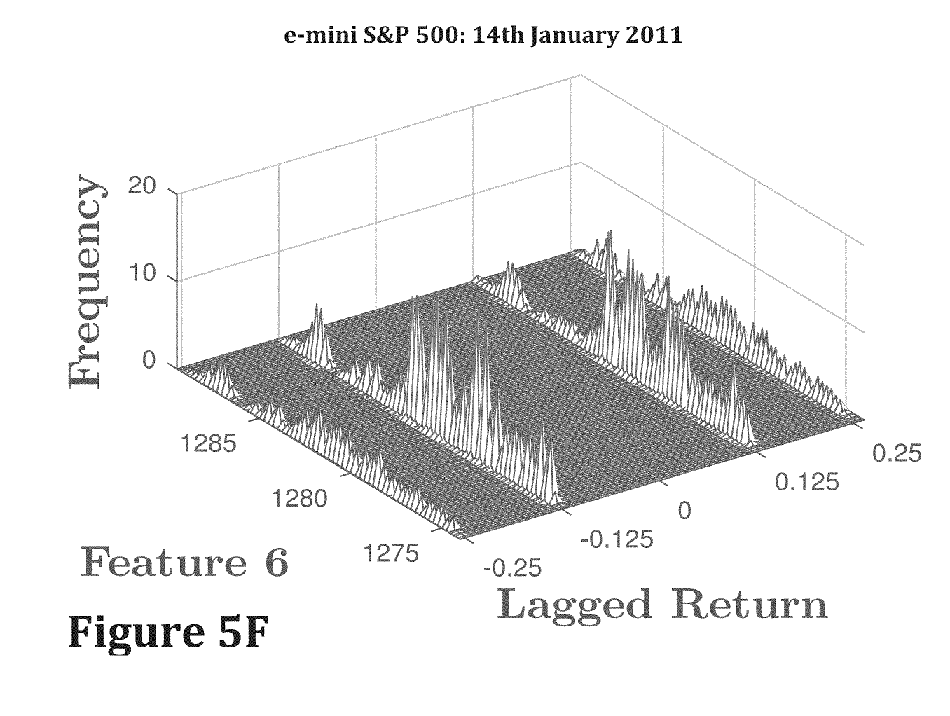

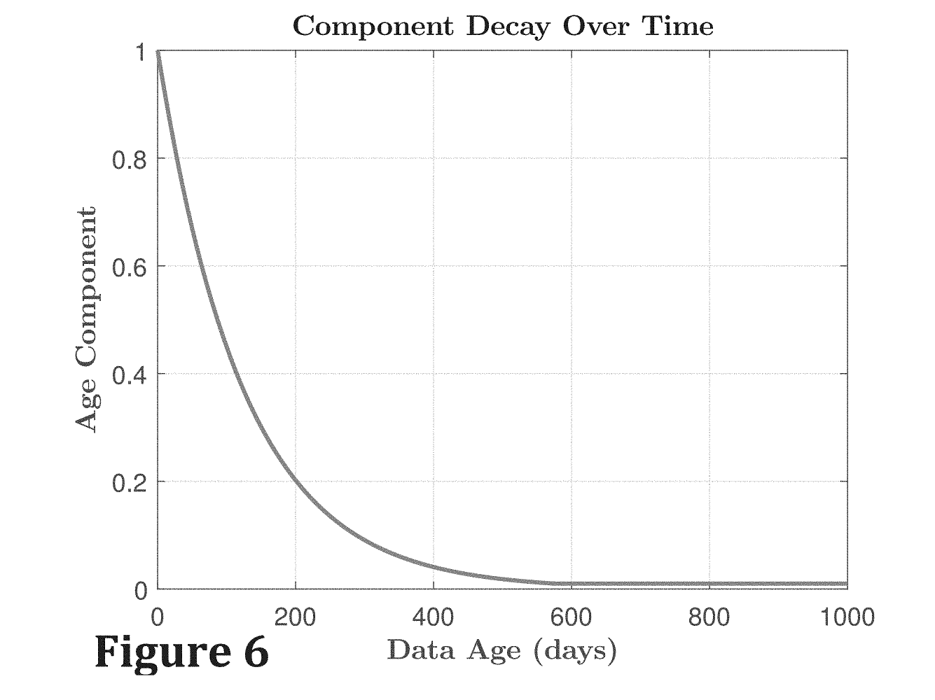

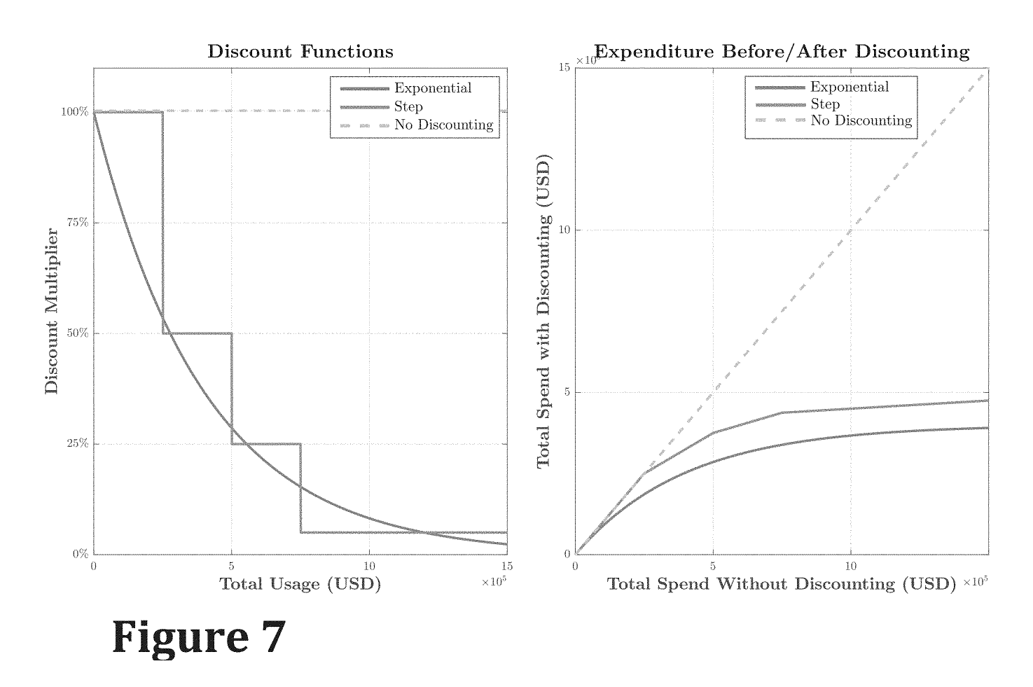

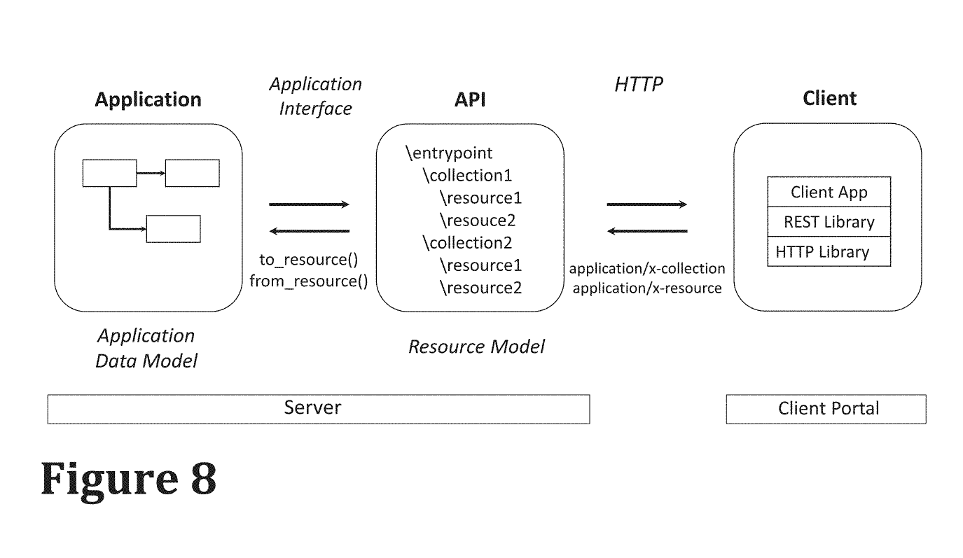

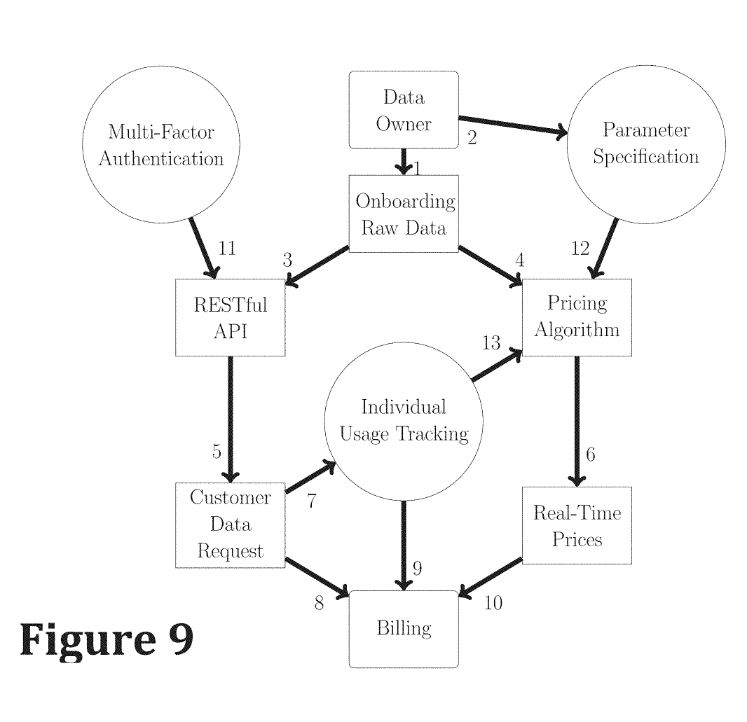

FIG. 2 shows Bayesian updating, and with each update, observed data yields a posterior distribution increasingly centred on the true parameter value. FIG. 3. shows data pricing function surface for the case of limit order book data, with parameters (w, λ, α)=(0.5, 0.008, 0.01). Superimposed is a snapshot of what the positions of different datasets on the pricing function surface would have been on Feb. 1, 2015. FIGS. 4A-4F show example features taken from order book data that might be used for data pricing. Each feature's timeseries is plotted in a lighter shade, with the feature's histogram superimposed in black. FIGS. 5A-5F show example joint distributions of data features with lagged return. For visualisation purposes, those data points for which the lagged return is zero have been removed from these plots. FIG. 6 shows exponential decay of the price's age component, with example rate parameter λ=0.008, FIG. 7 shows charts displaying the effect of discounting on data prices and on the total expenditure of a user. Different discount functions are shown. One is a continuous discount function that causes prices to decay exponentially with increased usage, so that DiscountMultiplier %=exp(−ρ×usage)×100%. The rate at which the discount increases is controlled by a parameter ρ>0. A step-wise discount function is also shown, where prices decay in stages at various usage thresholds. In the chart on the right we see how these discounting methods affect the total monthly bill that a customer would observe. As a comparison, the scenario in which no discounting occurs is shown as a dashed line. FIG. 8 shows a schematic of REST (Representational State Transfer) API design. REST is a popular standard specifying the correct use of standards such as HTTP and URIs when building web applications. REST defines a standard scheme for labelling and managing the resources of an application, as well as a standard set of high-level methods through which the resources can communicate with each other, and through which a client can interact with the application. FIG. 9 shows a graph describing the flow of data through the platform from owner to customer.

### Overview

Disclosed herein is a method is provided for pricing data for on-demand use through an on-line marketplace, which is a cloud-based venue consisting of multiple and independent suppliers and consumers of data. This method is in particular applicable to data which is large in size, complex in structure, sensitive and/or valuable to the data owner. An additional benefit of our system is that the method works when the data suppliers are disparate and possibly commercially competing entities.

The invention is a method to price data for on-demand consumption through on-line distribution.

The method comprises the following features: a mechanism whereby key elements of a dataset's value can be represented quantitatively; a mechanism whereby key features can be extracted from the data; a mechanism by which mutual information statistics can be calculated by combining data features; a mechanism by which a collection of datasets can have relative values derived; a mechanism for smoothing volatile price movements of datasets; a mechanism by which the change in the value of data over time can be estimated; a mechanism by which price is dynamically changed in response to consumption by incorporating feedback from supply-demand curves, using Bayesian machine learning to dynamically update parameters; a mechanism for preventing inter-channel sales arbitrage; a mechanism whereby changing business needs allow a supplier to update the price generating functions; a mechanism by which heavy data consumption may be systematically discounted; a mechanism by which price information is managed by the marketplace owner and communicated to the consumer; and the mathematical technology which underlies these inventions is based on machine learning tasks using regression.

The method is described by Equation 3.

P_{data}=max(ϕ[ωI_{data}+(1−ω))A_{data}(t;λ)],α),

s·t ϕ,α>0, and 0<ω<1. (3)

Equation 3 combines two main variables to calculate the price, P_{data}, of a dataset (measured in USD per unit time). The first of these is the Information Content, I_{data}, of the dataset. This is a statistic that we calculate from the dataset and which we use to characterise the amount of valuable information in the data.

The second input, the Age Component A_{data}(t; λ), is calculated from the dataset's age t in unit time. In some settings current datasets may be more valuable to consumers than older datasets. Here the age component ensures that the price for a dataset decreases over time.

The pricing model is a weighted average of the information and age components. Both components lie between zero and one, and so the average is also in this interval. The model also contains fixed parameters ϕ, λ, α and ω that control the interaction between the age and information components and determine the shape of the final pricing surface.

The parameter λ is a rate parameter that determines the speed at which the age component decreases with time. The parameter ω controls the relative contributions from each component to the weighted average. The parameter ϕ is the scaling parameter, which translates the relative price distribution defined through the weighted average of I and A into real prices. This is then passed through a max function, max(⋅, α), which ensures all prices are greater than the floor parameter α, to give a final price.

The time units of the pricing model are flexible, and can be tailored to the dataset under consideration i.e it may be appropriate for certain datasets to be priced at hourly or even finer time resolution, whereas others might be more suitably priced per day. Importantly, the pricing method operates independently of this specification.

A plot of the pricing function surface with example parameters is given in FIG. 3.

### Feature Extraction Mechanism

Features extraction is a popular approach to quantitative data analysis. There are many widely used feature extraction algorithms. Primarily the features that are discussed here are time series. When the data under consideration is time series data, the extracted features also have a time series format. However, for non time series data, such as medical images, features may be discrete values or even categorical variables.

For any given dataset, there may be multiple parametrisations of the data. That is, there are often many different ways to choose features to represent data. For any specified feature, every data point in a dataset will induce a value for that feature, and so there is a corresponding feature distribution across the dataset. It is these distributions that the pricing mechanism considers in measuring the value of I_{data} for a given dataset.

The first step in the method is to extract a set of descriptive features, denoted as {F₁, . . . , Fₖ, . . . , F_{N}}, from the dataset. The aim of this feature extraction mechanism is to characterise the amount of statistical regularity in a dataset. This statistical regularity is indicative of the predictability of patterns and structures within the dataset.

The descriptive features, the form of which will be specific to the particular type of data under consideration, provide this characterisation. I_{data} is a metric constructed from them, which is then used in the pricing mechanism.

We also extract a value feature, denoted Fᵥ, which is selected as being the key driver of value in the dataset. This is typically the feature or property of the data that consumers of the data would be most interested in understanding, modelling or predicting.

As an example, with limit order book data (a dataset described in the invention background) the descriptive features are typically time series of a range of standard order book metrics, sampled with one second frequency, following the approaches of Kercheval & Zhang [6] and Fletcher et al. [7]. Example plots of time series features from an order book are shown in FIG. 4.

These standard metrics include features such as:

The Bid-Ask Spread, (P_{best}^{ask}−P_{best}^{bid}), defined as the difference between the lowest ask order price, denoted P_{best}^{ask}, and highest bid order price, denoted P_{best}^{bid} (i.e the best priced orders of each type) at a given point in time.

The Mid-Price,

$$( \frac{{P}_{best}^{ask} + {P}_{best}^{bid}}{2} ) ,$$

defined as the mid-point between the best bid order's price and best ask order's price.

The total bid and ask order volumes, (Vᵢ^{ask}, Vᵢ^{bid}), at each book level (i=1, 2, 3, . . . ) in the order book (where i=1 is the best price, i=2 the next best etc.). This is the sum of the individual order sizes at each price level e.g If there are three outstanding orders.

The bid/ask prices, (Pᵢ^{ask}, Pᵢ^{bid}), at each book level (i=1, 2, 3, . . . ).

The average Intensity, (λ_{Δt}^{ma}, λ_{Δt}^{mb}, λ_{Δt}^{la}, λ_{Δt}^{lb}, λ_{Δt}^{ca}, λ_{Δt}^{cb}), for each possible order type. This is the recent average arrival rate of a given order type: market ask/bid orders (λ_{Δt}^{ma}, λ_{Δt}^{mb}), limit ask/bid orders (λ_{Δt}^{la}, λ_{Δt}^{lb}) and ask/bid order cancellations (λ_{Δt}^{ca}, λ_{Δt}^{cb}). The average is computed over the time interval (t−Δt, t).

The Order Accelerations,

$$\{ \frac{d {λ}^{ma}}{dt} , \frac{d {λ}^{mb}}{dt} , \frac{{dt}^{la}}{dt} , \frac{d {λ}^{l b}}{dt} \} ,$$

are the derivatives of the average intensity features, computed as the average rate of change over the last second.

Kernel features, for example using a Gaussian radial basis function kernel of the form

$$K ( x , {x}^{′} ) = exp ( - \frac{{‖ x - {x}^{′} ‖}^{2}}{2 {σ}^{2}} ) ,$$

as is used in Fletcher et al. [7]. Kernel transformations project the physical features into a latent kernel feature space that makes further statistical analysis more tractable and more effective.

For the value feature in limit order book data, a time series feature Fᵥ=(fₜ)ₜ₌₁ⁿ describing the Lagged Return would be used. Lagged returns are the time-adjusted movements in the bid/ask mid-price, as shown in equation 4 i.e at time t, the lagged return is the change in the mid-price between time t and t+1. Knowledge of this feature's dynamics is the key goal of market participants seeking to trade optimally within the market.

$${f}_{t} = {y}_{t + 1} - {y}_{t} \\ where \\ {y}_{t} {=}^{def} \frac{1}{2} ( {P}_{best}^{ask} + {P}_{best}^{bid} ) at time t . \qquad ( 4 )$$

As another example, we can consider descriptive features that might be used to characterise a medical imaging dataset, such as:

Whether the data is pre-labelled by a domain expert with medical classification. Data that has already had value added to it by expert analysis is naturally of more value than unlabelled datasets.

The resolution of the image data. Images with higher resolution contain more information, and so are more valuable.

Standard latent features commonly used in a range machine vision tasks e.g principal component analysis basis images.

Localized variance and acceleration features e.g features that describe the rate of change of objects such as colour, brightness etc. in an image.

For on-line marketplace metadata and sharing economy datasets, such as user metadata on a peer-to-peer transport platform e.g Uber or Lyft, salient descriptive features of a dataset could include:

The age of the user.

User demographics e.g., gender.

The amount of rides purchased per month.

A user's cellphone model. For mobile platforms, the model/manufacturer of device used to access the market is often correlated with and hence indicative of other users behaviours.

The geographical distribution of rides.

The average length of a journey, both in distance and in time.

### Feature Combining Mechanism

The pricing method evaluates the extent to which the descriptive features {F₁, . . . , Fₖ, . . . , F_{N}} can be used to predict the value feature Fᵥ. It achieves this by measuring the Mutual Information I(Fₖ; Fᵥ) between each of the descriptive features and the value feature.

This calculation examines and evaluates the joint value-feature/descriptive-feature distributions, of the type show in FIG. 5. This mutual information characterisation is more robust than than standard covariance-based metrics of the joint distribution. For any two random variable X and Y with joint probability density p(x, y) and respective marginal densities p(x) and p(y), the Covariance is defined as

$$\begin{matrix}Cov ( X , Y ) := {σ}_{XY}^{2} \\ = 𝔼 [ XY ] - 𝔼 [ X ] 𝔼 [ Y ] \\ = {\sum }_{x , y} [ p ( x , y ) - p ( x ) p ( y ) ] xy\end{matrix}$$

Compared with the expression for mutual information given in equation 1, it can be shown that the expression for covariance captures mainly the linear dependencies between X and Y. By contrast, mutual information characterises higher order non-linear relationships, and so is a more effective metric for comparing and combining features.

By summing the information contained within each descriptive feature/value feature joint distribution, as shown in equation 5, the method calculates a statistic that captures the total raw information content of a dataset, denoted I_{data}^{raw}.

$${I}_{data}^{raw} = {\sum }_{k = 1}^{N} I ( {F}_{k} , {F}_{v} ) \qquad ( 5 )$$

Where there is a low level of information about the value feature contained within the descriptive features, the respective values for I(Fₖ; Fᵥ) are low, and so the statistic I_{data}^{raw} is small. Conversely, the more information that the descriptive features contain about the value feature, the larger the I(Fₖ; Fᵥ) statistics are. Hence, higher values for I_{data}^{raw} are assigned to datasets with a high statistical regularity.

In the application of the mechanism to limit order book data, the method proceeds by calculating the joint distributions of the lagged return time series with each of the chosen descriptive features, a range of which have already been listed above.

In the case of real-valued time series features, this requires an intermediate step to approximate the joint feature distribution, whereby the real-valued feature pair observations are sorted into a finite grid of bins, and the joint feature distribution is approximated a histogram over these bins.

To do this, the domain of each feature is partitioned into a finite number of intervals e.g for a real valued random variable X we choose a finite set of B_{X} values {x₁, . . . , x_{B}_{_{X}}} which then defines a set of intervals, (−∞, x₁]={x:x≤x₁}, (x₁, x₂]={x:x₁<x≤x₂}, . . . , (x_{B}_{_{X}}₋₁, x_{B}_{_{X}}]={x:x_{B}_{_{X}}₋₁<x≤x_{B}_{_{X}}}, (x_{B}_{_{X}},∞)={x:x_{B}_{_{X}}<x}.

The partitions of each feature domain induce a square grid on the joint feature domain, defining the bin grid.

The joint distribution between the lagged return time series and the descriptive feature under consideration is then approximated by calculating the frequencies of observations for each bin, and then using this joint histogram to approximate the true value of the mutual information. For a set of T joint feature observations {(xₜ, yₜ)}ₜ₌₁^{T}, and denoting the bin frequencies as,

$${C}_{ij} = {\sum }_{t = 1}^{T} \{ {x}_{t} ∈ [ {x}_{i - 1} , {x}_{i} ] , {y}_{t} = ∈ [ {y}_{j - 1} , {y}_{j} ] \}$$

and the marginal frequencies as, respectively,

$${C}_{i} = {\sum }_{t = 1}^{T} \{ {x}_{t} ∈ [ {x}_{i - 1} , {x}_{i} ] \}$$

$${C}_{j} = {\sum }_{t = 1}^{T} \{ {y}_{t} ∈ [ {y}_{j - 1} , {y}_{j} ] \}$$

we arrive at the expression for the joint information of two time-series features as

$$I ( X ; Y ) = \frac{1}{T} {\sum }_{i , j = 1}^{{B}_{X}} {\sum }_{j = 1}^{{B}_{Y}} {C}_{i , j} log \frac{T \times {C}_{i , j}}{{C}_{i} {C}_{j}} .$$

### Dataset Ranking Mechanism

The metric in equation 5 allows us to consistently compare the relative value of multiple datasets of the same type. To get the relative information content I_{data} we normalise the raw values as in equation 6 to get an information distribution over a collection of datasets C, with each dataset having an associated I_{data} value between zero and one.

$${I}_{data} = \frac{{I}_{data}^{raw}}{{max}_{d ∈ 𝒞} ( {I}_{d}^{raw} )} \qquad ( 6 )$$

One example application of the mechanism would be to a collection of health records, where a single dataset is the anonymous health record of a unique individual. For each individual record, features would be extracted, and the raw mutual information values between the features calculated. The normalising mechanism would result in record with a high level of valuable information being assigned a value of I_{data} close to one, and those with little information of value being assigned values near zero.

Another example of an applicable dataset collection would be a set of limit order book datasets from a single marketplace or financial exchange, where each asset traded within that market generates data, and these datasets are ranked by their information content relative to each other.

In the specific case of financial data for the FTSE 100, taken from a single trading day on the London Stock Exchange, the ranking mechanism results in a distribution for the I_{data} values over the 100 datasets.

The security names and the information content values of their associated dataset assigned by the mechanism in the collection are displayed in the Table 1 below (the intermediate values have been omitted, with the most/least valuable datasets shown.

### Price Smoothing Mechanism

For some types of data that can be priced using the invention, datasets may be generated over time in a way that is relevant to their valuation. This is true, for example, in the case of economic matching data. For a given commodity or asset traded in a marketplace, there will be new economic matching data created each trading day as a result of activity in the marketplace. Hence, a new dataset containing information on the day's trades in that asset will become listed on the platform each new day, denoted d, and this dataset will induce an information statistic I_{data}^{d} describing its value.

For such datasets, the method provides a mechanism for linking the prices of a series of datasets over time, displayed in equation 7. The information statistics are smoothed over time by taking an average over the previous T datasets, with T being chosen relative to the category of data being considered.

$${I}_{smoothed}^{d} = \frac{1}{T} [ {I}_{data}^{d} + … + {I}_{data}^{d - T} ] . \qquad ( 7 )$$

Such a mechanism is desirable in these instances because consumers of these datasets will often be seeking to investigate how certain properties of the dataset evolve over time.

Hence, the value of a such a dataset depends not only on its own information statistics, but also on the information statistics induced by previous and related datasets. The smoothing mechanism incorporates this dependence into the dataset's price.

For example, with financial limit order book data, choosing T=21 (approximately the scale of one trading month) would be reasonable. This gives the information content a dependence on the most recent previous trading days, allowing unusual trading events (e.g market crashes) to influence order book prices beyond just the day of the event, and reducing the variance in dataset prices from volatile information content values.

Another example dataset where a smoothing mechanism would be appropriate is on-line marketplace metadata. The purchasing behaviour of consumers using on-line marketplaces such as Ebay or Amazon is frequently sold to advertisers, who use it to better target their marketing campaigns towards users judged most likely to be interested in their product.

The value in on-line shopping metadata is not just in knowing what users are purchasing right now (through analysing recent datasets) but is also in finding and predicting long-term trends in consumer behaviour. Hence it is appropriate that prices for current metadata depend not only on the information contained within that data but also on the value of historical metadata datasets, and the smoothing mechanism ensures that this dependence is present in the pricing structure.

### Time-Dependent Component

After I_{data}, the second variable input to the pricing mechanism described in equation 3 is the Age Component A_{data}, calculated from the dataset's age t as shown in Equation 8. Current datasets are generally more valuable to data consumers, and the construction of A_{data}(t; λ) makes the prices output by the method reflect this.

A_{data}(t; λ) takes a value of one for the most recent datasets (for which t=0) and decays exponentially, controlled by the rate parameter λ, approaching to zero as age increases. A chart showing this decay is displayed in FIG. 6.

A(t;λ)=exp(−λt), s·tλ>0. (8)

TABLE 1
LOB dataset ranking using feature extraction and mutual information
statistics

| Security Name | Security Ticker | I_{data} |
|---|---|---|
| HSBC Holdings PLC | HSBA LN Equity | 1.000 |
| Standard Chartered PLC | STAN LN Equity | 0.992 |
| BP PLC | BP LN Equity | 0.867 |
| Rio Tinto PLC | RIO LN Equity | 0.793 |
| AstraZeneca PLC | AZN LN Equity | 0.766 |
| British American Tobacco PLC | BATS LN Equity | 0.761 |
| GlaxoSmithKline PLC | GSK LN Equity | 0.738 |
| BHP Billiton PLC | BLT LN Equity | 0.705 |
| Vodafone Group PLC | VOD LN Equity | 0.655 |
| Royal Dutch Shell PLC | RDSA LN Equity | 0.621 |
| . | . | . |
| . | . | . |
| . | . | . |
| Sage Group PLC | SGE LN Equity | 0.064 |
| Fresnillo PLC | FRES LN Equity | 0.059 |
| Hammerson PLC | HMSO LN Equity | 0.058 |
| Admiral Group PLC | ADM LN Equity | 0.051 |
| Merlin Entertainments PLC | MERL LN Equity | 0.049 |
| Dixons Carphone PLC | DC LN Equity | 0.043 |
| 3i Group PLC | III LN Equity | 0.043 |
| Meggitt PLC | MGGT LN Equity | 0.042 |
| Intu Properties PLC | INTU LN Equity | 0.036 |
| Coca-Cola HBC AG | CCH LN Equity | 0.032 |

The choice of parameter λ affects the speed at which the value of A_{data} decreases with time. The value chosen for this parameter depends on the class of data being valued, and it may sometimes be appropriate to select different decay rates for different datasets.

For example, when valuing entertainment media data, such as film or music, for on-line distribution, different genres will have markedly different values profiles over time. Classic films, such as The Godfather or Citizen Kane would likely hold their value well over time, consistently attracting a dedicated audience and repeat consumption. other categories, including cult films like Pulp Fiction or seasonal films like It's a Wonderful Life, would similarly decay in value slowly. Accordingly the appropriate value for A selected when pricing these datasets would be close to zero.

In contrast, media in chart-oriented popular music and club music experience has an extremely steep decay in value over time. In this industry the rate of turnover of new music is very high, and the popularity of any one piece of media is short-lived—usually only lasting a few months—after which demand for that particular single is greatly reduced and the media is far less valuable. When pricing such data, values for A that are relatively large. in comparison with the film media categories already mentioned, would be appropriate.

In the context of limit order book data, many data consumers seek to leverage historical limit order book data in order to inform their trading practices.

The range of historical data that is of interest to such consumers greatly depends on the types of trading algorithms and strategies they operate, and on the types of patterns they are seeking within the data. Consumers are concerned with identifying stationary patterns within the data, but the time-scale of economic and financial dynamics can vary from very fast, microsecond-resolution patterns in market micro-structure, to slow moving daily or even monthly market trends.

High-frequency algorithmic traders, for example, would be almost solely interested in the most recent datasets. As a result of the constant modifications to market micro-structure caused by changes in exchange software, hardware and system architecture, older datasets can be of little use in designing and testing contemporary high-frequency strategies.

Furthermore, the matching data taken from the most recent trading days was generated in an environment highly similar to current market conditions. Signals in this data will be closely aligned with those observed in the market. Trading algorithms that have been tuned and optimised with this data will thus perform more effectively than those trained with non-contemporary historical data.

For these reasons, as was the case with entertainment media described above, the value of limit order book datasets decreases over time.

Older historical data still contains some value however. In particular, it may be used for the back-testing of long-term trading strategies and the identification of slow-moving market trends. This data may be of use to hedge funds with lower trading frequencies, seeking to identify intelligent mid-term and long-term investments rather than expose trading arbitrage opportunities. Such consumers would seek to acquire many months and even years of consecutive market data in order to run their analysis and conduct quantitative research.

For many academic research purposes, the age of the data is of little relevance at all. Academics are not typically concerned with tuning the parameters of their models to match current market conditions, but rather seek to expose fundamental properties of financial markets, both in the short-term dynamics of market micro-structure and in long-term, slow moving patterns. Regardless, the age of the data used in experiments will have little bearing on the validity of any research conclusions drawn.

The value decay of limit order book data is further evidenced by the fact that one prominent financial exchange already operates a simplistic two-tiered pricing structure, where matching data that is older than three months is reduced in price by 30%. This suggests that an appropriate choice for λ is approximately 0.01 for these datasets.

### Dynamic Price Adjustment Mechanism

The final prices output by the method are dependent not only on the data being valued but also on a parameter selection process, which fixes the model parameters described in the Pricing Mechanism above. Here we detail a quantitative method for selecting the scaling parameter ϕ. To select an optimal value for ϕ we analyse the behaviour of platform users. We can reasonably expect the data usage to follow a Gaussian distribution, such that for a dataset, which we denote here as d, the usage U_{d} (which can be measured in any preferred units of time) can be modelled as

U_{d}˜ [symbol] (μ_{d},σ_{d}²),

where μ_{d} and σ_{d} are the respective mean and standard deviation of the Gaussian usage distribution.

Analysing real observed usage data, the mechanism use standard Bayesian Inference techniques (as described in greater detail in the Background of the Invention and in Murphy[58]), to continuously update and adjust μ_{d} and σ_{d} towards their true values.

The expected total expenditure, [symbol] , of a user is a function of their average data usage, μ_{d}, and the data's price per unit of time P_{d}(ϕ), summed across all datasets:

$$𝔼 [ 𝒯 ] = {\sum }_{d} {μ}_{d} {P}_{d} ( φ ) .$$

Hence, the parameter ϕ can be set optimally to maximize expected revenue (given assumptions on the user's total budget and on the independence of price and average usage). If the data usage behaviours undergo any regime change, the method will cause the pricing model to adjust automatically in response.

### Parallel Sales Channel Adjustment Mechanism

The method provides a mechanism for controlling and preventing inter-channel sales arbitrage in cases where suppliers are vending their data in parallel through channels other than the marketplace described herein. This mechanism automatically links the pricing algorithm to a database containing information on the pricing structures listed on parallel vending channels.

The mechanism then incorporates this information into the parameter selection process. The information on parallel vending streams allows the invention to calibrate the prices listed on the platform so that both sales channels price the data offering consistently. This calibration may require translation between different distribution mechanisms e.g a rental model vs single purchase. This mechanism prevents either stream competing with the other, and further prevents arbitrage between these channels.

For example, one popular financial exchange currently distributes one year of their market data, consisting of over five thousand individual securities, for a fixed price of £14,000. If this data was distributed through the date pricing and distribution mechanism described herein, the parallel sales channel adjustment mechanism would calibrate the price scaling parameter ϕ, such that the expected expenditure on datasets accessed through the rental model by a consumer who currently accesses the data through the single-purchase channel is approximately equal to their current expenditure.

This calibration requires dataset-specific knowledge regarding the typical usage behaviours associated with that data, which can be found using the Bayesian inference techniques described above. The prices can then be scaled accordingly so that the above criteria are met, and so that inter-channel sales arbitrage is prevented.

### Supplier-Driven Price Adjustment Mechanism

The method allows for further alterations in the pricing structure to be made by the data owners on a per-dataset basis. Through this mechanism, each contributor to the platform is able to exactly match their sales policy with their broader business requirements.

At a high level, they can have input into the parameter process, adding their own calibration specifications, denoted (δ_{α}, δ_{ω}, δ_{λ}, δ_{ϕ}), to the method. In this way the final parameter settings are found by adjusting the quantitative parameter selections (α_{mod}, ω_{mod}, λ_{mod}, ϕ_{mod}) found by the model, calculated as

α=α_{mod}+δ_{α}

ω=ω_{mod}+δ_{ω}

λ=λ_{mod}+δ_{λ}

ϕ=ϕ_{mod}+δ_{ϕ}

As well as making global parameter calibrations, data owners can make low-level adjustments modifying specific prices for any of their datasets listed on the platform, deviating from the prices determined algorithmically by the pricing model described in equation 3.

This mechanism provides data owners with general pricing flexibility for their products, and the scope for fine-tuning of data prices gives data owners the ability to carefully manage the overall supply of their property. This provision is especially important to suppliers who are legally obliged to market their data (as is the case in certain financial markets), and whose business interests may be in minimizing supply rather than maximizing immediate revenues from their data offering.

### Systematic Discounting Mechanism

Another constituent mechanism of the invention is a provision for discounting prices charged to specific users relative to their total platform consumption. For a given user, the method tracks their total spend and moderates the prices for data access downwards by applying a discount multiplier to the base price P_{data} calculated through equation 3. This multiplier, denoted F(u), is calculated according to equation 9, where u denotes the total amount of data already consumed (i.e the sum spend in USD on data access) in the current billing period. The discounted prices, denoted P_{discount}, are then calculated according to equation 10.

F(u)=exp(−ρu). (9)

P_{discount}=F(u)×P_{data} (10)

The rate at which the discount increases is controlled by a parameter ρ>0. This framework is illustrated further in FIG. 7, displaying a chart showing how the total spend of a user grows logarithmically, rather than linearly, with respect to the quantity of data consumed over time.

This provision is necessary because the total consumption of data consumers may not scale linearly. A pricing structure that is reasonable for one set of consumers may be unrealistic for another set of users.

One example of this would be with limit order book data. Academic researchers and small-scale trading operations will only have the capacity to utilise relatively small quantities of data. By comparison, large banks, hedge funds and high-frequency proprietary trading houses will have large teams of developers and researchers, with advanced infrastructures and practically unlimited computational resources. These advantages allow them to process several orders of magnitude more market data. If this disparity in capacity for consumption is larger than the disparity in financial means between the heavy users and light users, then it is appropriate to offer discounted prices to heavy users. This user-specific discounting makes the data offering more attractive to heavy users and encourages them to consume as much data as possible, without affecting prices offered to small-scale consumers.

### Data Distribution Mechanism

The invention prices data for on-line, on-demand distribution. Raw data is provided by suppliers to the marketplace owner, who carries out any necessary normalising or cleaning of the data before placing it on the marketplace. The marketplace is an on-line e-commerce platform, accessible by consumers through a RESTful API interface (see FIG. 8) secured with multi-factor authentication.

Once data is on-boarded, the pricing method is triggered, incorporating any specifications from the supplier, and the resulting prices are displayed in real-time on the platform. As users make API calls accessing data, their requests are logged, and this usage tracking is used both to inform future prices and to automate a monthly billing framework. A flowchart displaying these stages is shown in FIG. 9.

### REFERENCES

[1] M. D. Gould, M. A. Porter, S. Williams, M. McDonald, D. J. Fenn, and S. D. Howison, “Limit order books,” Quantitative Finance, vol. 13, no. 11, pp. 1709-1742, 2013.
[2] M. Avellaneda and S. Stoikov, “High-frequency trading in a limit order book,” Quantitative Finance, vol. 8, no. 3, pp. 217-224, 2008.
[3] F. Guilbaud and H. Pham, “Optimal high-frequency trading with limit and market orders,” Quantitative Finance, vol. 13, no. 1, pp. 79-94, 2013.
[4] S. Baruch, “Who benefits from an open limit order book?” The Journal of Business, vol. 78, no. 4, pp. 1267-1306, 2005.
[5] W. K. Hardie, N. Hautsch, and A. Mihoci, “Modelling and forecasting liquidity supply using semiparametric factor dynamics,” Journal of Empirical Finance, vol. 19, no. 4, pp. 610-625, 2012.
[6] A. N. Kercheval and Y. Zhang, “Modelling high-frequency limit order book dynamics with support vector machines,” Quantitative Finance, vol. 15, no. 8, pp. 1315-1329, 2015.
[7] T. Fletcher, Z. Hussain, and J. Shawe-Taylor, “Multiple kernel learning on the limit order book.” in WAPA, 2010, pp. 167-174.
[8] J. M. Bandman, N. J. Ondyak, E. M. Sorenson, and B. A. Weinstein, “System and method for displaying and/or analyzing a limit order book,” U.S. Patent US20 120 072 333A1, 2005.
[9] B. T. I. C. LLC, “Financial market data/analysis global share & segment sizing 2015,” 2015.
[10] A. Narayanan, J. Bonneau, E. Felten, A. Miller, and S. Goldfed, Bitcoin and Cryptocurrency Technologies. Princeton University Press, 2016.
[11] H. Raventós and M. Anadón Rosinach, “Bitcoin data analysis,” 2012.
[12] D. Ron and A. Shamir, “Quantitative analysis of the full bitcoin transaction graph,” in Financial Cryptography and Data Security. Springer, 2013, pp. 6-24.
[13] A. Loera, “Method of making, securing, and using a cryptocurrency wallet,” U.S. Patent US20 150 227 897A1, 2014.
[14] J. Buchdahl, Fixed odds sports betting: Statistical forecasting and risk management. Summersdale Publishers LTD-ROW, 2003.
[15] E. Franck and E. Verbeek, “Prediction accuracy of different market structures—bookmakers versus a betting exchange,” International Journal of Forecasting, 2009.
[16] M. A. S. D. P. L. V. Williams, “Market efficiency in person-to-person betting,” Economica, 2006.
[17] A. Black, “Betting exchange system,” U.S. Pat. No. 7,690,991B2, 2010.
[18] V. Krishna, Auction Theory. Elsevier, 2010.
[19] F. Gul and E. Stacchetti, “The english auction with differentiated commodities,” Journal of Economic theory, vol. 92, no. 1, pp. 66-95, 2000.
[20] R. P. M. P. Milgrom, “Method and system for combinatorial auctions with bid composition restrictions,” U.S. Pat. No. 6,718,312B1, 1999.
[21] C. G. DeLaCruz, “System and method for conducting a trial on-line auction,” U.S. Patent US20 040 205 015, 2003.
[22] J. Bernard, “System and method for advertising, auctioning, renting or selling rental properties and/or real estate,” U.S. Patent US20 140 195 444 A1, 2013.
[23] A. E. Roth, A. Ockenfels et al., “Last minute bidding and the rules for ending second price auctions: evidence from ebay and amazon auctions on the internet,” American economic review, vol. 92, no. 4, pp. 1093-1103, 2002.
[24] G. Lewis, “Asymmetric information, adverse selection and online disclosure: The case of ebay motors,” The American Economic Review, vol. 101, no. 4, pp. 1535-1546, 2011.
[25] R. S. Bamford and S. W. Gabriel, “Pricing engine for electronic commerce,” U.S. Pat. No. 7,496,543B1, 2001.
[26] C. W. Tsai, C. F. Lai, M. C. Chiang, and L. T. Yang, “Data mining for internet of things: A survey,” Communications Surveys & Tutorials, IEEE, vol. 16, no. 1, pp. 77-97, 2014.
[27] D. Bandyopadhyay and J. Sen, “Internet of things: Applications and challenges in technology and standardization,” Wireless Personal Communications, vol. 58, no. 1, pp. 49-69, 2011.
[28] M. Chui, M. Löffler, and R. Roberts, “The internet of things,” McKinsey Quarterly, vol. 2, no. 2010, pp. 1-9, 2010.
[29] A. Pal, C. Bhaumik, A. Ghose, and P. Sinha, “Social network graph based sensor data analytics,” U.S. Patent US20 140 101 255A1, 2011.
[30] A. Goel, M. A. R. Shuman, B. Gupta, A. Aggarwal, and S. Sharm, “Analytics engines for iot devices,” U.S. Patent US20 140 244 836A1, 2013.
[31] D. MacKay, Sustainable Energy-without the hot air. UIT Cambridge, 2008.
[32] P. Clarke, P. V. Coveney, A. F. Heavens, J. Jaykkä, B. Joachimi, A. Karastergiou, N. Konstantinidis, A. Korn, R. G. Mann, J. D. McEwen, S. de Ridder, S. Roberts, T. Scanlon, E. P. S. Shellard, and J. A. Yates, “Big data in the physical sciences: challenges and opportunities,” Alan Turing Institute, 2016.
[33] T. S. Thompson and R. O. S. Baron, “System and method providing for real-time weather tracking and storm movement prediction,” U.S. Pat. No. 5,717,589A, 1995.
[34] F. Zausa, E. Comizzoli, B. Nazzari, J. Michelez et al., “Enhanced post-well analyses by data integration over entire projects lifecycle,” in Offshore Mediterranean Conference and Exhibition. Offshore Mediterranean Conference, 2015.
[35] K. Zhao and D. Sui, “Drilling data quality control via wired drill pipe technology,” in Control Conference (CCC), 2015 34th Chinese. IEEE, 2015, pp. 7883-7888.
[36] T. Baumgartner, Y. Zhou, E. v. Oort et al., “Efficiently transferring and sharing drilling data from downhole sensors,” in IADC/SPE Drilling Conference and Exhibition. Society of Petroleum Engineers, 2016.
[37] M. S. Bahorich, “Method of geophysical exploration,” U.S. Pat. No. 5,226,019A, 1992.
[38] F. Clayer, H. Henneuse, and J. Sancho, “Method for acoustic transmission of drilling data from a well,” U.S. Pat. No. 5,289,354A, 1990.
[39] I. Yoo, P. Alafaireet, M. Marinov, K. Pena-Hernandez, R. Gopidi, J.-F. Chang, and L. Hua, “Data mining in healthcare and biomedicine: A survey of the literature,” Journal of medical systems, vol. 36, no. 4, pp. 2431-2448, 2012.
[40] J. C. Prather, D. F. Lobach, L. K. Goodwin, J. W. Hales, M. L. Hage, and W. E. Hammond, “Medical data mining: Knowledge discovery in a clinical data warehouse.” in Proceedings of the AMIA annual fall symposium. American Medical Informatics Association, 1997, p. 101.
[41] W. Raghupathi and V. Raghupathi, “Big data analytics in healthcare: Promise and potential,” Health Information Science and Systems, vol. 2, no. 1, p. 3, 2014.
[42] C. Brackett and V. Anand, “Method, system, and computer product for collecting and distributing clinical data for data mining,” U.S. Patent US20 040 083 217A1, 2002.
[43] K. R. Andrews and G. Luikart, “Recent novel approaches for population genomics data analysis,” Molecular Ecology, vol. 23, no. 7, pp. 1661-1667, 2014.
[44] G. Lennon, “Own your dna,” MIT Technology Review, 2016.
[45] L. Dai, X. Gao, Y. Guo, J. Xiao, and Z. Zhang, “Bioinformatics clouds for big data manipulation,” Biology direct, vol. 7, no. 1, pp. 1-7, 2012.
[46] P. Merel, “Organization, visualization and utilization of genomic data on electronic devices,” U.S. Patent U.S. Pat. No. 20,140,033 125 A1, 2010.
[47] R. Botsman and R. Rogers, What's mine is yours: how collaborative consumption is changing the way we live. Collins London, 2011.
[48] P. Vogel and C. Merwen, “The sharing economy: I don't need a drill, i need a hol in my wall,” Barcalys Equity Research, Tech. Rep., 2015.
[49] H. Yee and B. Ifrach, “Aerosolve: Machine learning for humans,” Airbnb Open Source, 2015.
[50] L. Chen, A. Mislove, and C. Wilson, “Peeking beneath the hood of uber,” in Proceedings of the 2015 ACM Conference on Internet Measurement Conference. ACM, 2015, pp. 495-508.
[51] C. E. Shannon, “A mathematical theory of communication,” Bell Systems Technical Journal, vol. 27, pp. 379-423, 1948.
[52] T. M. Cover and J. A. Thomas, Elements of information theory. John Wiley & Sons, 2012.
[53] D. J. MacKay, Information theory, inference and learning algorithms. Cambridge university press, 2003.
[54] Y. Liu, “Mutual information with absolute dependency for feature selection in machine learning models,” U.S. Patent US20 150 278 703A1, 2014.
[55] F. Weng and Y. Zhou, “Fast feature selection method and system for maximum entropy modeling,” U.S. Patent US20 050 021 317A1, 2003.
[56] A. H. Quazi, “Method and system for processing acoustic signals,” U.S. Pat. No. 5,841,735A, 1996.
[57] C. K. Chow and C. N. Liu, “Mutual information derived tree structure in an adaptive pattern recognition system,” U.S. Pat. No. 3,588,823A, 1968.
[58] K. P. Murphy, Machine learning: a probabilistic perspective. MIT press, 2012.
[59] I. Guyon and A. Elisseeff, “An introduction to variable and feature selection,” The Journal of Machine Learning Research, vol. 3, pp. 1157-1182, 2003.
[60] S. Wold, K. Esbensen, and P. Geladi, “Principal component analysis,” Chemometrics and intelligent laboratory systems, vol. 2, no. 1-3, pp. 37-52, 1987.
[61] P. A. Estévez, M. Tesmer, C. A. Perez, and J. M. Zurada, “Normalized mutual information feature selection,” Neural Networks, IEEE Transactions on, vol. 20, no. 2, pp. 189-201, 2009.
[62] H. Peng, F. Long, and C. Ding, “Feature selection based on mutual information criteria of max-dependency, max-relevance, and min-redundancy,” Pattern Analysis and Machine Intelligence, IEEE Transactions on, vol. 27, no. 8, pp. 1226-1238, 2005.
[63] K. Torkkola, “Feature extraction by non parametric mutual information maximization,” The Journal of Machine Learning Research, vol. 3, pp. 1415-1438, 2003.
[64] K. H. Jarman, D. S. Daly, K. K. Anderson, and K. L. Wahl, “Method of identifying features in indexed data,” U.S. Pat. No. 6,253,162B1, 1999.
[65] D. Meyerzon and H. Li, “Ranking search results using feature extraction,” U.S. Pat. No. 7,716,198B2, 2004.
[66] J. Bem, G. R. Harik, J. L. Levenberg, N. Shazeer, and S. Tong, “Ranking documents based on large data sets,” U.S. Pat. No. 7,231,399B1, 2003.

1. A method for determining a fair price of data for distribution in a collaborative consumption setting via an electronic network, the method comprising:
the price of the data is determined using a quantitative statistical model,
a first input to the statistical model is pricing data from any complementary sales channels,
a second input to the statistical model is age of the data,
a third input into the statistical model is information content of the data.

2. A method for determining the information content of data based on using informational entropy to calculate the value of features,
for this claim:
descriptive features are extracted from raw data using a variety of machine learning techniques,
the value feature can be defined in such a way that it encapsulates the end-user value of the data,
mutual information can be calculated for descriptive features in the presence of the value feature and the output ranked.

3. A web-based system for distributing data in an on-line marketplace setting,
for this claim:
a method to record metadata associated with users' API calls,
a method for using this metadata as an input to the pricing algorithm, allowing Bayesian updating of probabilities, and
a method for data owners to update pricing model parameters in light of new information.
